(19) United States
(12) Patent Application Publication
(10) Pub. No.: US 2022/0005113 A1
(43) Pub. Date: Jan. 6, 2022

(54) VEHICLE MANAGEMENT SYSTEM AND VEHICLE MANAGEMENT METHOD

(71) Applicant: HONDA MOTOR CO., LTD., Tokyo (JP)

(72) Inventors: Toru Kimura, Tokyo (JP); Kenta Urata, Wako-shi (JP); Kanako Ikeda, Tokyo (JP)

(21) Appl. No.: 17/358,418

(22) Filed: Jun. 25, 2021

(30) Foreign Application Priority Data
Jul. 2, 2020 (JP) 2020-114644

(51) Int. Cl. G06Q 30/06

(52) U.S. Cl. CPC G06Q 30/0645

(57) ABSTRACT

A vehicle management system that manages use and charging of an electric vehicle to be shared by a plurality of users accepts a reservation by using a reservation accepting unit if a use time zone corresponding to the reservation is within a charging time zone set in schedule information and if a use purpose of the reservation is a non-driving purpose.

### INCORPORATION BY REFERENCE

The present application claims priority under 35 U.S.C. § 119 to Japanese Patent Application No. 2020-114644 filed on Jul. 2, 2020. The content of the application is incorporated herein by reference in its entirety.

### BACKGROUND OF THE INVENTION

### Field of the Invention

The present invention relates to a vehicle management system and a vehicle management method.

### Description of the Related Art

In order to utilize vehicles in various and efficient manners in a car sharing service, a technology has been proposed which provides a car sharing service also for users for a non-movement purpose (see Japanese Patent Laid-Open No. 2019-192019).

According to Japanese Patent Laid-Open No. 2019-192019, reservation information includes purpose information by which either movement purpose use for using a vehicle mainly for a movement use or non-movement purpose use not for using the vehicle mainly for the movement use is identified, and a vehicle allocation unit allocates a vehicle in consideration of the purpose information. For example, in a case where there are a plurality of movement use time zones to which reservations for the movement purpose use are allocated, the non-movement purpose use is allocated to a time between the plurality of movement purpose time zones.

While Japanese Patent Laid-Open No. 2019-192019 describes that a non-movement purpose use (called “non-driving use”) is allocated to a free time of a vehicle, it is not disclosed that the technology is applied to an electric vehicle. Since an electric vehicle is charged during a standby time, there is fewer free times in which neither movement-purpose use (also called “renting”) nor charging is performed than those of a non-electric vehicle, and the length of a continuous free time is short. Thus, when the technology disclosed in Japanese Patent Laid-Open No. 2019-192019 is applied to an electric vehicle, it is difficult to allocate a non-driving use to a free time of the electric vehicle, and improvement of the operating ratio is difficult.

The present invention has been made in view of such background, and it is an object of the present invention to improve the operating ratio of an electrical vehicle requiring charging.

### SUMMARY OF THE INVENTION

As a first aspect for achieving the object above, there is provided a vehicle management system that manages use and charging of an electric vehicle to be shared by a plurality of users, the system including a storage unit storing schedule information in which a use time zone and a charging time zone for the electric vehicle are set, and a reservation accepting unit determining whether a reservation for the electric vehicle is to be accepted or not based on the schedule information, wherein the reservation includes information by which a use time zone for the electric vehicle and a use purpose of the electric vehicle can be identified, and the reservation accepting unit accepts the reservation if the use time zone corresponding to the reservation is within the charging time zone set in the schedule information and if the use purpose is a non-driving purpose.

The vehicle management system may further include an amount-of-electricity identifying unit identifying a required amount of electricity based on details of the reservation, and a charging time identifying unit identifying a required charging time based on the required amount of electricity. The reservation accepting unit may accept the reservation if the reservation is for the non-driving purpose and if a free time to which the required charging time corresponding to the reservation can be allocated exists before a use time zone set immediately after the use time zone corresponding to the reservation.

The vehicle management system may further include an information managing unit setting, in the schedule information, the use time zone corresponding to the reservation and a charging time zone corresponding to the reservation if the reservation is accepted. If the reservation is for the non-driving purpose and if a free time to which the required charging time corresponding to the reservation can be allocated exists between the use time zone corresponding to the reservation and a use time zone set immediately before the use time zone, the information managing unit may set the charging time zone corresponding to the reservation within the free time.

The vehicle management system may further include a vehicle control unit which can externally control air conditioning in the electric vehicle. The vehicle control unit may selectively perform pre-air conditioning control which starts an air conditioning operation at a time before the use time zone corresponding to the reservation in accordance with the use purpose corresponding to the accepted reservation.

In the vehicle management system, if the use purpose is a non-driving purpose involving getting into the vehicle, the vehicle control unit may perform pre-air conditioning control which operates air conditioning in the electric vehicle before the electric vehicle is started to use and, if the use purpose is a non-driving purpose not involving getting into the vehicle, may not perform the pre-air conditioning control.

In the vehicle management system, the reservation accepting unit may have a vehicle selecting unit selecting an electric vehicle to be reserved based on details of the reservation, and if the use purpose corresponding to the reservation is a non-driving purpose, the vehicle selecting unit may select an electric vehicle to be reserved in accordance with details of the non-driving purpose.

As a second aspect for achieving the object above, there is provided a vehicle management method to be executed by a computer for managing use and charging of an electric vehicle to be shared by a plurality of users, the method including a reservation accepting step of determining whether a reservation for the electric vehicle is to be accepted or not based on schedule information in which a use time zone and a charging time zone for the electric vehicle are set, wherein the reservation includes information by which a use time zone for the electric vehicle and a use purpose of the electric vehicle can be identified, and the reservation accepting step accepts the reservation if the use time zone corresponding to the reservation is within the charging time zone set in the schedule information and if the use purpose is a non-driving purpose.

According to the present invention, the operating ratio of an electric vehicle requiring charging can be improved.

### BRIEF DESCRIPTION OF THE DRAWINGS

FIG. 1 is a configuration diagram of a vehicle management system;

FIG. 2 shows an example of vehicle information;

FIG. 3 shows an example of schedule information;

FIG. 4 schematically shows schedules of rental vehicles based on schedule information;

FIG. 5 shows an example of vehicle selection information;

FIG. 6 is a flowchart showing operations of reservation accepting processing;

FIG. 7A and FIG. 7B are diagrams for use in explanation of the reservation accepting processing;

FIG. 8A and FIG. 8B are diagrams for use in explanation of the reservation accepting processing;

FIG. 9A and FIG. 9B are diagrams for use in explanation of the reservation accepting processing; and

FIG. 10 is a flowchart showing operations relating to pre-air conditioning.

### DETAILED DESCRIPTION OF THE PREFERRED EMBODIMENTS

Embodiments of the present invention are described below with reference to drawings.

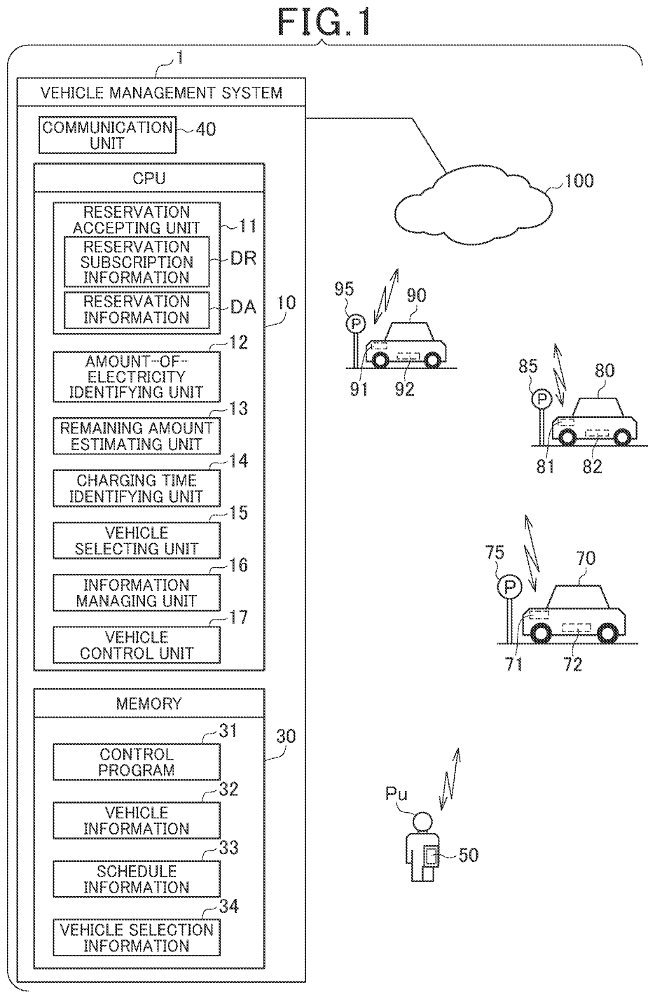

FIG. 1 is a configuration diagram of a vehicle management system 1 according to an embodiment of the present invention. The vehicle management system 1 provides a service that rents a vehicle (hereinafter, called “rental vehicle”). The rental vehicle is a vehicle for car-sharing to be shared by a plurality of users or a vehicle for car rental. In other words, the vehicle management system 1 provides a service that rents a rental car by car sharing or car rental. FIG. 1 exemplarily shows three rental vehicles 70, 80 and 90 as partial rental vehicles, and the vehicle management system 1 is accordingly described by using those vehicles 70, 80 and 90. The rental vehicles may not be limited to a vehicle for car sharing or car rental, but embodiments are widely applicable to vehicles to be shared by a plurality of users.

The rental vehicles 70, 80 and 90 are electric vehicles powered by storage batteries 72, 82 and 92, respectively, and operations of the rental vehicles 70, 80 and 90 are controlled by electronic control units (ECUs) 71, 81 and 91, respectively. The ECU 71, 81 and 91 each comprises a processor and a communication module that includes a transceiver/receiver. The rental vehicles 70, 80 and 90 are parked in standby locations 75, 85 and 95, respectively, for renting and returning. The standby locations 75, 85 and 95 are, for example, a station or a car rental shop, and the standby locations 75, 85 and 95 have charging devices by which the storage batteries 72, 82 and 92 of the rental vehicles 70, 80 and 90 can be charged, respectively. The charging devices may be either fixed or portable.

The vehicle management system 1 is configured by a computer system including a central processing unit (CPU) 10, a memory 30, a communication unit 40 and so on and can be referred to as a vehicle renting apparatus. Through a communication network 100, the communication unit 40 (transceiver/receiver) has an antenna and communicates with the ECUs 71, 81 and 91 mounted in the rental vehicles 70, 80 and 90, respectively, and with a communication terminal 50 carried by a user Pu of the vehicle management system 1. The user Pu is an example of a user who uses the vehicle renting service provided by the vehicle management system 1. The communication terminal 50 is a portable communication terminal such as a smartphone, a cellar phone and a tablet computer.

The memory 30 stores a control program 31 for the vehicle management system 1, vehicle information 32, schedule information 33, and vehicle selection information 34. The vehicle information 32 is information regarding all rental vehicles managed by the vehicle management system 1.

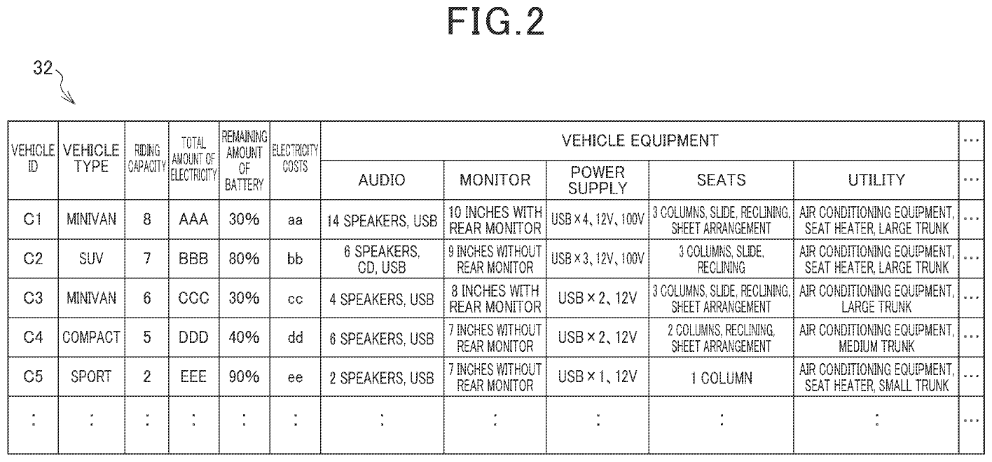

FIG. 2 shows an example of the vehicle information 32. As shown in FIG. 2, the vehicle information 32 is data describing, for each of rental vehicles managed by the vehicle management system 1, “VEHICLE IDENTIFICATION (ID)”, for identifying a vehicle, “VEHICLE TYPE INFORMATION” for identifying a vehicle type (also called “category”), “RIDING CAPACITY” for identifying a maximum number of passengers, “TOTAL AMOUNT OF POWER OF STORAGE BATTERY” for identifying battery specifications or a maximum traveling distance of the vehicle, “BATTERY REMAINING AMOUNT” indicating the current remaining amount of the storage battery, “ELECTRICITY COSTS” indicating a rate of electric power consumption of the rental vehicle, and “VEHICLE EQUIPMENT” for identifying devices equipped in the vehicle.

At least the “BATTERY REMAINING AMOUNT” of the vehicle information 32 is updated as required based on transmission information transmitted from the rental vehicle. The “TOTAL AMOUNT OF POWER OF STORAGE BATTERY” may be regarded as a fixed value because its variation is smaller than that of the “BATTERY REMAINING AMOUNT” but may be updated as required based on the transmission information transmitted from the rental vehicle because the “TOTAL AMOUNT OF POWER OF STORAGE BATTERY” decreases in the long term. The information such as the “BATTERY REMAINING AMOUNT” may be directly transmitted from the rental vehicle to the vehicle management system 1, or a communication function may be provided in the charging device deployed in each of the standby locations 75, 85 and 95 so that the charging device may obtain the information above from the rental vehicle and transmit the information to the vehicle management system 1.

This vehicle information 32 may be created by the vehicle management system 1 or may be created by a device other than the vehicle management system 1. For example, information such as the “BATTERY REMAINING AMOUNT” of the rental vehicle may be received by a device other than the vehicle management system 1, the vehicle information 32 may thus be created, and the created vehicle information 32 may be transmitted to the vehicle management system 1.

Details of the vehicle information 32 may be changed, or the number of details may be increased or reduced, as required. For example, while the vehicle type information is shown as information such as minivan, SUV, compact or sport, the vehicle type information may be more finely categorized information or may include a specific vehicle type name.

As the “VEHICLE EQUIPMENT”, FIG. 2 describes information regarding usability of a vehicle excluding driving-related information, such as information regarding an audio, a monitor, a power supply, seats, and utility. By using this “VEHICLE EQUIPMENT” information as required, a rental vehicle that better fits to user Pu's tastes and use purpose can be more easily specified.

As the information regarding the audio, information is adopted by which a music playback environment can be identified, and, more specifically, information such as the number of speakers arranged in the interior of the vehicle, an input/output interface (such as a USB) for sound data, and playable media (such as a CD) is adopted. As the information regarding the monitor, information is adopted by which a video playback environment can be identified, and, more specifically, information such as a monitor size and the presence/absence of a rear monitor is adopted.

As the information regarding the power supply, information is adopted by which a usable power supply can be identified, and, more specifically, information such as the number of USB ports, the presence/absence of a cigarette socket power supply (such as 12 V), and the presence/absence of an AC outlet (100 V) is adopted.

As the information regarding the seats, information is adopted by which comfort and usability of seats can be identified, and, more specifically, information such as the number of columns of seats, the presence/absence of a slide function and a reclining function, and the presence/absence of seat arrangement is adopted.

As the information regarding the utility, information is adopted by which usability of the vehicle excluding the audio, monitor, power supply and seats described above can be identified, and, for example, information such as the presence/absence of air-conditioning equipment, the presence/absence of a seat heater, the size of a trunk, and the presence/absence of a function relating to handicapped people is adopted.

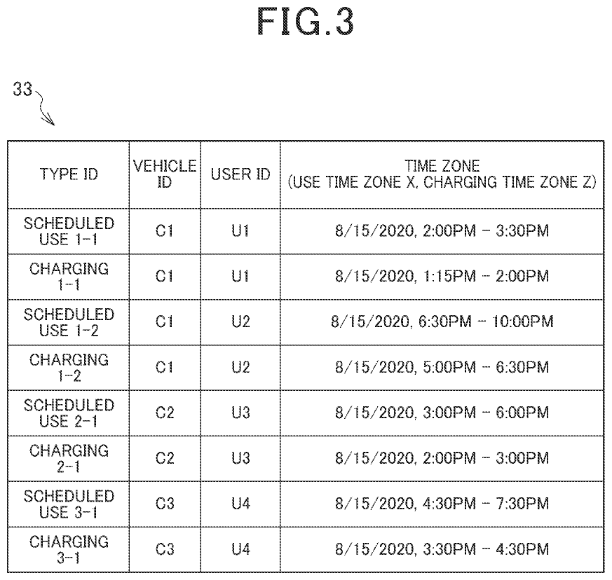

The schedule information 33 is data including settings of a use time zone corresponding to a time period when the rental vehicle is being rented and a charging time zone for charging the rental vehicle. FIG. 3 shows an example of the schedule information 33. As shown in FIG. 3, the schedule information 33 is data describing, in association, a type ID for identifying a type of a reserved time zone (use time zone or charging time zone), a vehicle ID indicating a reserved rental vehicle, a user ID for identifying a reservation holder (user), and a reserved time zone.

Based on this schedule information 33, the reserved use time zone and the charging time zone can be easily managed for each of the rental vehicles 70, 80 and 90. Hereinafter, Reference X is given to the use time zone as required, and Reference Z is given to the charging time zone as required.

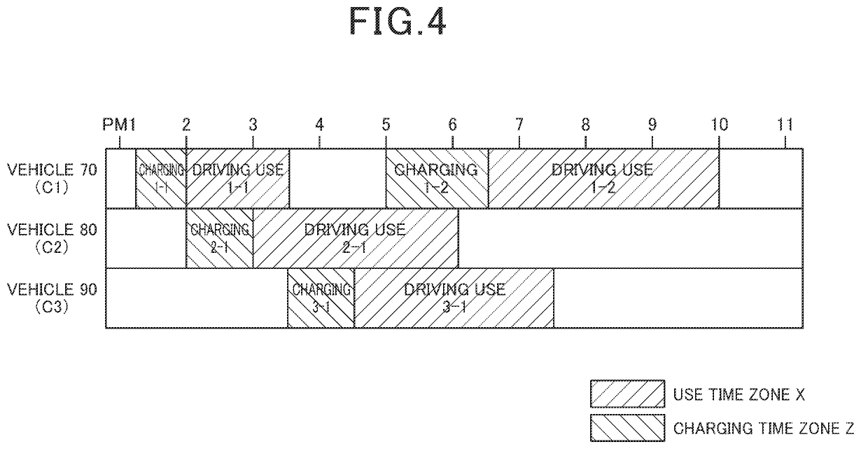

FIG. 4 schematically shows schedules of the rental vehicles 70, 80 and 90 based on the schedule information 33 shown in FIG. 3. The vehicle IDs of the rental vehicles 70, 80 and 90 are values C1, C2 and C3, respectively.

As shown in FIG. 4, the use time zone X is identified for the rental vehicle 70 (the vehicle with vehicle ID=value C1) based on details of SCHEDULED USES 1-1 and 1-2 under the type IDs in FIG. 3. The charging time zone Z for the rental vehicle 70 is identified based on details of CHARGING 1-1 and 1-2 under the type IDs in FIG. 3.

The charging time zones Z indicated by the type IDs of CHARGING 1-1, 1-2 are set immediately before the use time zones X of SCHEDULED USES 1-1, 1-2, respectively, by an information managing unit 16, which is described below. The length of the charging time zone Z is set to a time in which an amount of power to be consumed while the vehicle is being rented in the immediately subsequent use time zone X can be charged. This can suppress a situation where the storage batteries 72, 82 and 92 are charged more than necessary.

The expression “situation where the storage batteries are charged more than necessary” refers to a situation where the storage batteries are charged excessively beyond the charged amount required in the use time zone X. By suppressing the “situation where the storage batteries are charged more than necessary”, reduction of life of the storage batteries can be suppressed.

As shown in FIG. 4, for the rental vehicle 80 (the vehicle with vehicle ID=C2), the use time zone X and the charging time zone Z are identified based on details under the type IDs of SCHEDULED USE 2-1 and CHARGING 2-1 in FIG. 3 allocated to the rental vehicle 80. The charging time zone Z indicated by the type ID of CHARGING 2-1 is set to have a sufficient length by using the free time immediately before the use time zone X of SCHEDULED USE 2-1, like the case of the rental vehicle 70.

Also, for the rental vehicle 90 (the vehicle with vehicle ID=C3), the use time zone X and the charging time zone Z are identified based on details under the type IDs of SCHEDULED USE 3-1 and CHARGING 3-1 in FIG. 3 allocated to the rental vehicle 90. The charging time indicated by the type ID of CHARGING 3-1 is set to have a sufficient length by using the free time immediately before the use time zone X of USE SCHEDULE 3-1, like the cases of the rental vehicles 70 and 80.

For example, when the standby locations 75, 85 and 95 (see FIG. 1) for the rental vehicles 70, 80 and 90 are attended facilities, a human performs renting and charging operations for the rental vehicles 70, 80 and 90 based on the schedule information 33. On the other hand, when the standby locations 75, 85 and 95 are unattended facilities, the renting and charging operations for the rental vehicles 70, 80 and 90 are preferably performed without humans based on the schedule information 33.

As a method for performing the renting operation without humans, a publicly known method such as a method using, for example, a virtual key may be applied. As a method for performing the charging operation without humans, a method may be applied in which, for example, the charging devices are configured to be communicable with the vehicle management system 1 by using the communication network 100 and the charging devices charge the rental vehicles 70, 80 and 90 based on the schedule information 33. Also in an attended facility, the renting and charging operations for the rental vehicles 70, 80 and 90 may be performed without humans.

In order to improve the operating ratio of a rental vehicle requiring charging, the vehicle management system 1 provides a service that rents a rental vehicle while being charged to a user who satisfies a predetermined condition. According to this embodiment, the expression “user who satisfies a predetermined condition” refers to a user who requests to use a rental vehicle for a non-driving purpose. In this case, the charging time zone Z of each of the rental vehicles may be available based on the schedule information 33.

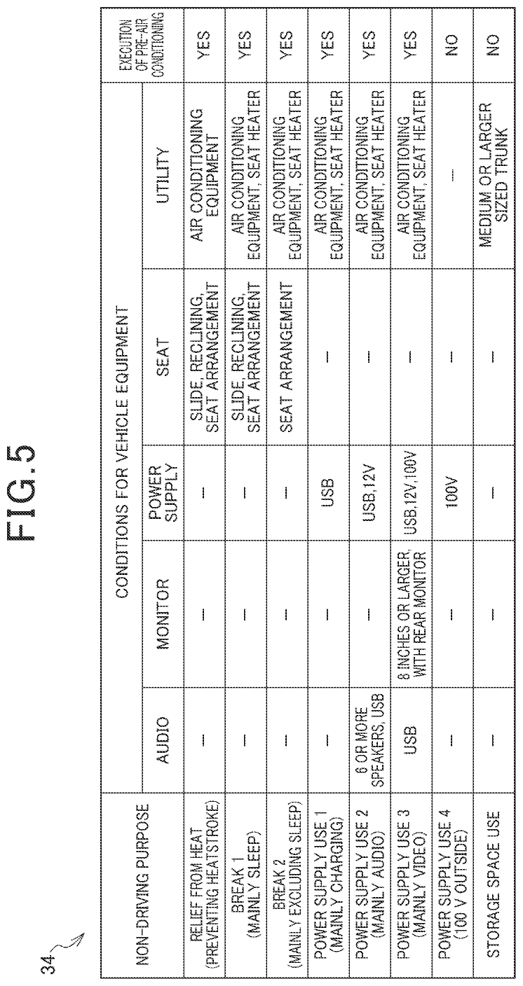

The vehicle selection information 34 describes information for selecting an electric vehicle in accordance with details of a non-driving purpose. FIG. 5 shows an example of the vehicle selection information 34.

As shown in FIG. 5, the vehicle selection information 34 includes, for each of specific examples of finely divided non-driving purposes, information indicating conditions of vehicle equipment required for the non-driving purpose and information indicating execution/non-execution of pre-air conditioning. The conditions of vehicle equipment describe equipment required for each of the audio, monitor, power supply, seats and utility, and Reference “-” is given in FIG. 5 to equipment that is not particularly necessary.

The pre-air conditioning is control which operates an air conditioner in a rental vehicle and keeps the interior of the rental vehicle at a proper temperature before a time of start of the use of the rental vehicle and is also called “pre-air conditioning control”. As exemplarily shown in FIG. 5, when the non-driving purpose is a purpose involving getting into the vehicle, the execution of the pre-air conditioning is set to “YES”, and, if the non-driving purpose is a purpose not involving getting into the vehicle (“POWER SUPPLY USE 4” and “STORAGE SPACE USE” in FIG. 5), the execution of the pre-air conditioning is set to “NO”.

Referring to FIG. 5, specific examples of the non-driving purpose include “RELIEF FROM HEAT (PREVENTING HEATSTROKE)” for using the rental vehicle mainly for the purpose of relief from the heat or preventing heatstroke, “BREAK 1 (MAINLY SLEEP)” for using the rental vehicle mainly for the purpose of sleeping, “BREAK 2 (MAINLY EXCLUDING SLEEP)” for using the rental vehicle mainly for the purpose of a break (such as shelter from rain) excluding sleeping, “POWER SUPPLY USE 1 (MAINLY SMARTPHONE POWER SUPPLY)” for using the rental vehicle mainly for the purpose of charging of a small device such as a smartphone, “POWER SUPPLY USE 2 (MAINLY AUDIO)” for using the rental vehicle mainly for the purpose of use of the audio device (such as online conference by voice), “POWER SUPPLY USE 3 (MAINLY VIDEO)” for using the rental vehicle mainly for the purpose of use of the video device (such as online video conference), “POWER SUPPLY USE 4 (100 V OUTSIDE)” for using the rental vehicle for using a 100-V device in outside of the vehicle and “STORAGE SPACE USE” for using a storage space of the rental vehicle.

FIG. 5 exemplarily shows that sliding and reclining of a seat, seat arrangement, and air conditioning equipment are necessary as vehicle equipment required for “RELIEF FROM HEAT (PREVENTING HEATSTROKE)”. Because of the seat functions above, the user can be laid down within the vehicle, and the body of the user can be cooled by the air conditioning equipment so that a preferable environment for heatstroke prevention can be easily acquired. FIG. 5 further exemplarily shows that sliding and reclining of a seat, seat arrangement, air-conditioning equipment and a seat heater are necessary as vehicle equipment required for “BREAK 1 (MAINLY SLEEP)”. With the equipment, an environment in which the user can sleep within the vehicle can be easily acquired. It should be noted that the seat heater may be vehicle equipment necessary for “BREAK 1 (MAINLY SLEEP)” only for a predetermined period including the winter.

The number of types of the specific examples shown in FIG. 5 can be increased and decreased, and the conditions for the equipment required in the specific examples may be changed as required. Exemplarily illustrating in FIG. 5 that both of the information indicating a condition of the vehicle equipment and the information indicating execution/non-execution of the pre-air conditioning are included, embodiments are not limited thereto. For example, the vehicle selection information 34 may only have the information indicating a condition of the vehicle equipment, and the information indicating execution/non-execution of the pre-air conditioning may be created in information different from the vehicle selection information 34. The execution/non-execution of the pre-air conditioning may be changed in accordance with the season.

By executing the control program 31 stored in the memory 30, the CPU 10 (processor) functions as a reservation accepting unit 11, an amount-of-electricity identifying unit 12, a remaining amount estimating unit 13, a charging time identifying unit 14, a vehicle selecting unit 15, the information managing unit 16, and a vehicle control unit 17, as shown in FIG. 1. The CPU 10 corresponds to a computer of the present invention, and the control program 31 includes a program for vehicle management of the present invention.

By communicating with the communication terminal 50 of the user Pu through the communication unit 40, the reservation accepting unit 11 obtains reservation subscription information DR describing reservation subscription details for a rental vehicle and performs reservation accepting processing for accepting a reservation based on the reservation subscription information DR. If the reservation is accepted, the reservation accepting unit 11 creates reservation information DA describing information regarding the reservation.

The reservation subscription information DR is data by which reservation subscription details can be identified and is data by which at least a use purpose of a rental vehicle, a use time zone X, the number of people who use the rental vehicle, and, for example, the user Pu who has subscribed for the reservation can be identified. The reservation information DA is data by which reservation details can be identified and is data by which at least the reserved rental vehicle, the use time zone X and the user Pu can be identified.

The amount-of-electricity identifying unit 12 performs processing for identifying a required amount of electricity E based on the reservation information DA. The required amount of electricity E corresponds to the amount of electricity with which a situation where a shortage of electricity occurs while the rental vehicle is being rented is avoided. If the use purpose is a driving purpose, the amount-of-electricity identifying unit 12 estimates the driving distance from the length of the use time zone X and calculates the required amount of electricity E, for example, based on the estimated driving distance and the electricity costs of the rental vehicle. It should be noted that the electricity costs can be identified from the vehicle information 32.

If the use purpose is a non-driving purpose, the amount-of-electricity identifying unit 12 calculates the required amount of electricity E, for example, based on the length of the use time zone X and the use purpose. In this case, for the non-driving purpose, a vehicle device to be used for the use purpose is preferably identified with reference to the vehicle selection information 34 shown in FIG. 5, and the amount of electricity to be consumed by the identified vehicle device is preferably included in the required amount of electricity E. For example, if the use purpose is “BREAK 1 (MAINLY SLEEP)”, the amount of electricity to be consumed by an air conditioning equipment and a seat heater is preferably included in the required amount of electricity E. For a non-driving purpose for which execution of the pre-air conditioning is set, the amount of electricity to be consumed by the pre-air conditioning is also preferably included in the required amount of electricity E.

The method for calculating the required amount of electricity E is not limited to the aforementioned method, but the required amount of electricity E may be calculated also in consideration of environmental information such as an outside air temperature (such as an average temperature on the rented date and time or a predicted temperature acquired from information on weather forecast), or past amounts of consumed electricity may be saved for each of use purposes, and the required amount of electricity E may be calculated based on the past amounts of consumed electricity under the same or similar condition (such as a use purpose or the length of the use time zone).

The remaining amount estimating unit 13 performs processing for estimating the remaining amount of a battery for a rental vehicle immediately before the use time zone X of the rental vehicle (corresponding to a time when use of the rental vehicle is started). For example, by obtaining the current remaining amount of the battery for the rental vehicle, estimating the charged and discharged amounts of electricity from the current time to the time when the use of the rental vehicle is started and acquiring a total sum of them, the remaining amount of the battery at the time when the use of the rental vehicle is started is estimated.

The current remaining amount of the battery for the rental vehicle can be identified from the vehicle information 32. The aforementioned charged and discharged amounts of electricity may be estimated by using, as required, the lengths of the use time zone X and charging time zone Z in the schedule information 33 and the electricity costs identified from the vehicle information 32. It should be noted that, instead of the method using the electricity costs described in the vehicle information 32, average electricity costs up to this point of the rental vehicle may be used. Alternatively, the remaining amount of the battery after the renting of the rental vehicle ends (upon return) may be obtained, and the remaining amount of the battery obtained immediately therebefore may be used as the current remaining amount of the battery for the rental vehicle. A wide variety of publicly known methods are applicable to the method for estimating, for example, the remaining amount of the battery.

The charging time identifying unit 14 calculates a required charging time TC based on the required amount of electricity E calculated by the amount-of-electricity identifying unit 12. More specifically, the charging time identifying unit 14 subtracts the remaining amount of the battery, which is estimated by the remaining amount estimating unit 13, from the required amount of electricity E, which is calculated by the amount-of-electricity identifying unit 12, and calculates the charging time required for charging the shortage amount of electricity acquired by the subtraction as the required charging time TC.

The calculation of the required charging time TC may consider specifications of the charging device or specifications relating to charging of the rental vehicle. A wide variety of publicly known methods are applicable to the method for calculating the required amount of electricity E or the required charging time TC.

When a reservation is accepted by the reservation accepting unit 11, the vehicle selecting unit 15 performs processing for selecting a rental vehicle to be reserved based on the details of the reservation. A wide variety of conventional processing is applicable for the vehicle selection for driving purposes. In selecting a vehicle for a non-driving purpose, a rental vehicle to be reserved is selected in accordance with details of the non-driving purpose with reference to the vehicle selection information 34.

When a reservation is accepted by the reservation accepting unit 11, the information managing unit 16 performs, for example, processing of updating the schedule information 33 based on the reservation information DA (hereinafter, called “schedule information update processing”).

The vehicle control unit 17 has a function of externally controlling the air conditioning in a rental vehicle by communicating with the rental vehicle through the communication unit 40. By using this function, the vehicle control unit 17 can perform the pre-air conditioning control for operating the air conditioning in a rental vehicle before the time when the use of the rental vehicle is started. It should be noted that a wide variety of publicly known configurations are applicable to the configuration for performing the pre-air conditioning control.

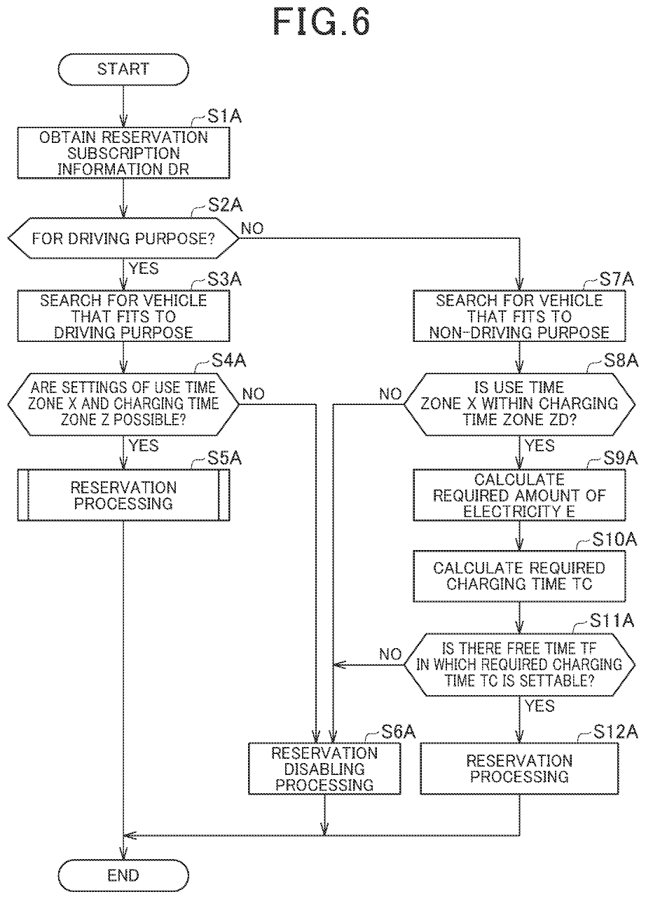

FIG. 6 is a flowchart showing operations of the reservation accepting processing. As an example, a case where there is a reservation subscription from the user Pu is described below.

As shown in FIG. 6, when the reservation accepting unit 11 obtains reservation subscription information DR describing details of a reservation subscription from the user Pu (step S1A), the reservation accepting unit 11 determines whether the use purpose included in the reservation subscription information DR is a driving purpose or a non-driving purpose or not (step S2A). If the use purpose is a driving purpose (YES in step S2A), the reservation accepting unit 11 executes processing in step S3A.

In the processing in step S3A, the reservation accepting unit 11 searches for a rental vehicle that fits to the driving purpose based on the reservation subscription information DR by using the vehicle selecting unit 15. For example, the vehicle selecting unit 15 searches for a rental vehicle that fits to the driving purpose based on conditions such as the number of sharing people included in the reservation subscription information DR with reference to the vehicle information 32.

Next, the reservation accepting unit 11 determines, for the rental vehicle found by the search, whether the setting of the use time zone X included in the reservation subscription information DR is possible and whether the setting of a proper charging time zone Z is possible or not with reference to the schedule information 33. Here, the expression “proper charging time zone Z” refers to a time having a length equal to the required charging time TC for the driving purpose, which is calculated by the charging time identifying unit 14.

If the settings of the use time zone X and the charging time zone Z are possible (YES in step S4A), the reservation accepting unit 11 determines that the reservation is possible and performs pre-defined reservation processing (step S5A). This reservation processing includes, for example, processing for setting the use time zone X and the charging time zone Z in the schedule information 33 for the rental vehicle.

If one of the settings of the use time zone X and the charging time zone Z is impossible (NO in step S4A), the reservation accepting unit 11 determines that the reservation is impossible and performs reservation-disabling processing (step S6A). The reservation-disabling processing includes, for example, processing of informing the user Pu of that the reservation is impossible or processing of prompting the user Pu to change the reservation subscription details.

If the use purpose of the rental vehicle is a non-driving purpose in the determination in step S2A (NO in step S2A), the reservation accepting unit 11 executes processing in step S7A.

In the processing in step S7A, the reservation accepting unit 11 searches for a rental vehicle according to details of the non-driving purpose based on the reservation subscription information DR by using the vehicle selecting unit 15. More specifically, the vehicle selecting unit 15 identifies a device required for the non-driving purpose included in the reservation subscription information DR with reference to the vehicle selection information 34 and searches for a rental vehicle having the device.

Next, the reservation accepting unit 11 determines, for the rental vehicle found by the search, whether the use time zone X included in the reservation subscription information DR is within a preset charging time zone or not with reference to the schedule information 33 (step S8A). The charging time zone in this case is a charging time zone set correspondingly to the use time reserved for the driving purpose, and hereinafter Reference “ZD” is given thereto as required for convenience of description.

If the use time zone X is within the charging time zone ZD (YES in step S8A), the reservation accepting unit 11 executes processing in step S9A.

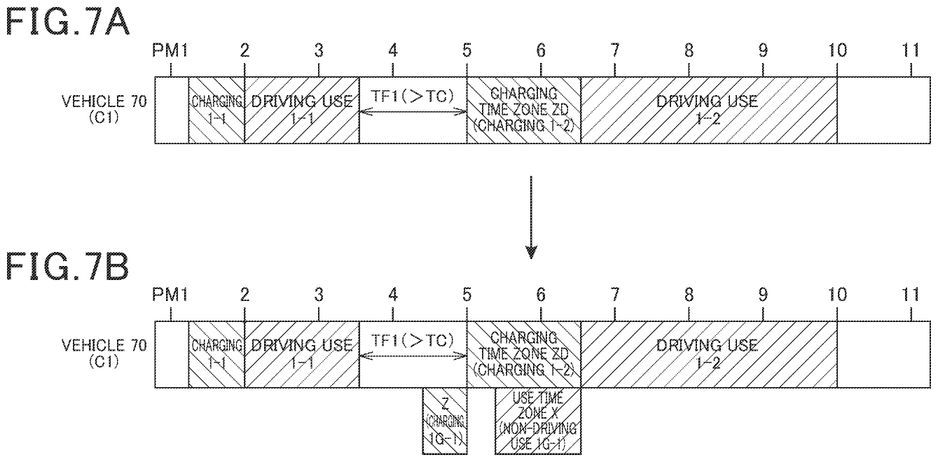

For example, FIG. 7A indicates a case where a charging time zone ZD (5:00 PM to 6:30 PM) indicated by “CHARGING 1-2” is reserved in the schedule information 33, and FIG. 7B indicates a case where there is a reservation subscription for a use time zone X (5:30 PM to 6:30 PM) indicated by “SCHEDULED NON-DRIVING 1G-1” within a charging time zone ZD indicated by “CHARGING 1-2”. In this case, because the determination in step S8A shown in FIG. 6 produces a positive result (YES in step S8A), the reservation accepting unit 11 executes processing in step S9A.

In the processing in step S9A, the reservation accepting unit 11 calculates a required amount of electricity E according to the non-driving purpose included in the reservation subscription information DR by using the amount-of-electricity identifying unit 12. In this case, as described above, a vehicle device to be used for the use purpose and the presence/absence of the pre-air conditioning are identified based on the vehicle selection information 34 shown in FIG. 5, and a required amount of electricity E is calculated so as to include power to be consumed by the identified vehicle device and power to be consumed by the pre-air conditioning.

Next, the reservation accepting unit 11 calculates a required charging time TC required for charging the required amount of electricity E by using the charging time identifying unit 14 (step S10A). Next, the reservation accepting unit 11 determines whether there is a free time TF longer than or equal to the length of the required charging time TC immediately before the use time zone X or not with reference to the schedule information 33 (step S11A). Here, the free time TF is a time in which the rental vehicle is not rented and is not charged, that is, a time excluding the use time zone and the charging time zone.

FIG. 7B indicates a case where there is a free time TF1 longer than or equal to the required charging time TC immediately before the use time zone X.

In this case, because the determination in step S11A produces a positive result (YES in step S11A), the reservation accepting unit 11, as shown in FIG. 6, determines that a charging time zone Z having the length of the required charging time TC is settable, determines that the reservation for the non-driving purpose is possible, and performs reservation processing (step S12A). This reservation processing includes, as indicated in FIG. 7B, processing for setting the use time zone X for the scheduled non-driving (indicated by “SCHEDULED NON-DRIVING 1G-1”) and the charging time zone Z (indicated by “CHARGING 1G-1”) in the schedule information 33 for the rental vehicle.

As indicated in FIG. 7B, because the power to be consumed in the use time zone X indicated by “SCHEDULED NON-DRIVING 1G-1” is charged in the charging time zone Z indicated by “CHARGING 1G-1” set in the free time TF1 immediately therebefore, the situation that a shortage of power occurs while the rental vehicle is being rented immediately thereafter (“DRIVING USE 1-2” in the case indicated in FIG. 7B) can be avoided. As indicated in FIG. 7B, by starting the charging indicated by “CHARGING 1-2” in the charging time zone ZD earlier by the amount equal to the charging time zone Z, a proper and continuous charging time can be acquired.

In one of the case where the use time zone X corresponding to the reservation for the non-driving purpose is not within the charging time zone ZD (NO in step S8A) and the case where there is no free time TF1 longer than or equal to the required charging time TC immediately before the use time zone X corresponding to the reservation for the scheduled non-driving (NO in step S11A), the reservation accepting unit 11 performs the reservation disabling processing in step S6A. The operations of the reservation accepting processing have been described above. This reservation accepting processing corresponds to a reservation accepting step of the present invention.

Having described that, in step S11A in FIG. 6, if there is a free time TF1 longer than or equal to the required charging time TC immediately before the use time zone X corresponding to a reservation for scheduled non-driving, it is determined that the reservation for the non-driving use is possible and the reservation processing is performed, embodiments are not limited thereto.

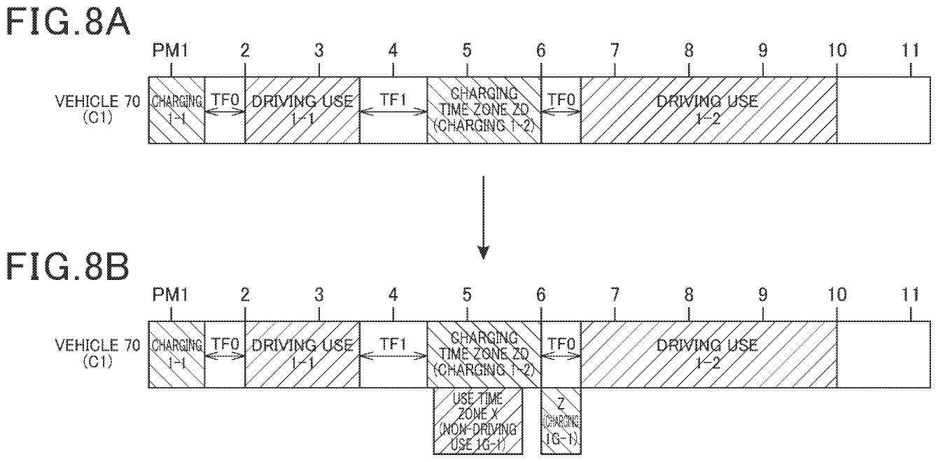

For example, as indicated in FIG. 8A, if there is a free time TF0 longer than or equal to the required charging time TC after the charging time zone ZD (5:00 PM to 6:30 PM) indicated by “CHARGING 1-2” and before the use time zone for the driving use indicated by the scheduled use 1-2 (corresponding to “DRIVING USE 1-2”) in the schedule information 33, a charging time zone Z (CHARGING 1G-1) corresponding to the reservation for scheduled non-driving may be set in the free time TF0, as indicated in FIG. 8B. Also in this case, a situation where a shortage of electricity occurs while the rental vehicle is being rented (corresponding to “DRIVING USE 1-2”) immediately after the use for the scheduled non-driving can be avoided.

As indicated in FIG. 8B, by delaying the time when the charging of CHARGING 1-2 indicated in the charging time zone ZD ends by the length equal to the charging time zone Z, a proper and continuous charging time can be acquired.

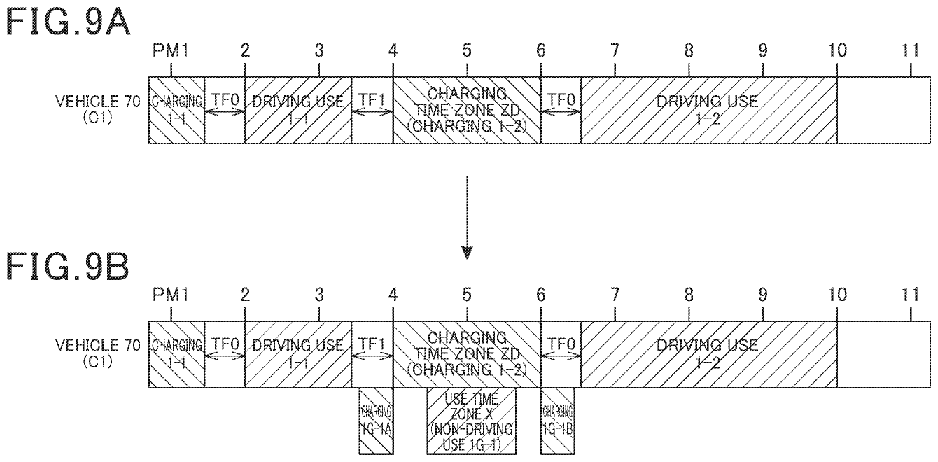

As indicated in FIG. 9A, when there are free times TF0 and TF1 immediately before and immediately after the use time zone X corresponding to the reservation for scheduled non-driving, the charging time zone Z for the required charging time TC (corresponding to CHARGING 1G-1A, 1G-1B) may be acquired by using both of the free times TF0 and TF1. As indicated in FIG. 9B, by performing the start of charging indicated by CHARGING 1-2 in the charging time zone ZD earlier and delaying the charging end time, a proper and continuous charging time can be acquired.

In all of the cases shown in FIG. 7A, FIG. 7B, FIG. 8A, FIG. 8B, FIG. 9A, and FIG. 9B, if there is a free time to which the required charging time TC corresponding to a reservation for scheduled non-driving can be allocated before a rental vehicle is rented (corresponding to “DRIVING USE 1-2”) immediately after use for scheduled non-driving, the reservation is accepted. Thus, a rental vehicle while being charged can be rented out for a non-driving purpose while avoiding a situation where a shortage of electricity in the rental vehicle occurs when the rental vehicle is rented out for a driving purpose.

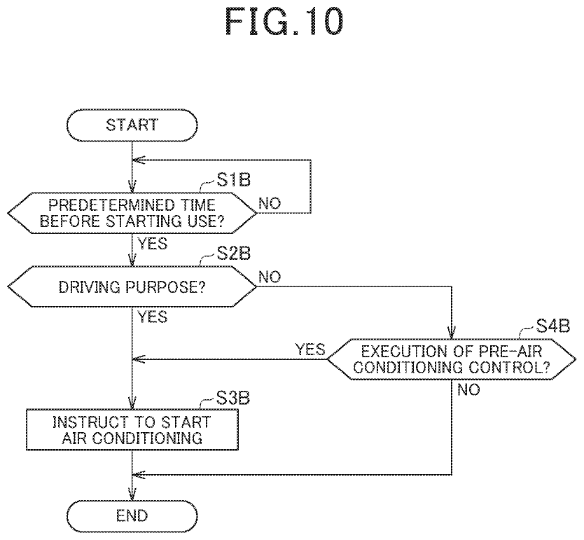

FIG. 10 is a flowchart showing operations relating to the pre-air conditioning.

As shown in FIG. 10, first, the vehicle control unit 17 determines whether a predetermined time before starting the use has been reached or not for each rental vehicle based on the schedule information 33 (step S1B). The expression “a predetermined time before starting the use” corresponds to a predetermined time before a use time zone X for both of driving use and non-driving use. The predetermined time here is set to a time that is sufficient for causing the interior of the vehicle to have a proper temperature during a time from start of the pre-air conditioning control up to the use time zone X.

If none of the rental vehicles is at the predetermined time before starting the use (NO in step SB), the vehicle control unit 17 executes the processing in step S1A again. Thus, the vehicle control unit 17 continuously monitors whether any one of the rental vehicles is at the predetermined before starting the use. When one of the rental vehicles reaches the predetermined time before starting the use (YES in step S1B), the vehicle control unit 17 determines whether the use purpose of the rental vehicle is the driving purpose or not (step S2B).

If the use purpose of the rental vehicle is the driving purpose (YES in step S2B), the vehicle control unit 17 instructs to start the air conditioning to the rental vehicle (step S3B) to perform the pre-air conditioning control.

On the other hand, if the use purpose of the rental vehicle is a non-driving purpose (NO in step S2B), the vehicle control unit 17 determines whether the non-driving purpose of the rental vehicle involves the pre-air conditioning control or not based on the vehicle selection information 34 (step S3B).

As shown in FIG. 5, “YES” for the execution of the pre-air conditioning is set for a non-driving purpose involving getting into the vehicle in the vehicle selection information 34. Therefore, for a non-driving purpose involving getting into the vehicle (YES in step S3B), the vehicle control unit 17 executes the processing in step S3B to perform the pre-air conditioning control. On the other hand, for a non-driving purpose not involving getting into the vehicle (NO in step S3B), the vehicle control unit 17 exits the processing once. Thus, the pre-air conditioning control is not performed. It should be noted that the processing is executed repeatedly at predetermined periods.

Having described, with reference to the flowchart shown in FIG. 10, that the pre-air conditioning control is performed for a reservation for a driving purpose and for a non-driving purpose involving getting into the vehicle, embodiments are not limited thereto. For example, the pre-air conditioning control may be performed only for a non-driving purpose involving getting into the vehicle, or the pre-air conditioning control may be performed only for a predetermined non-driving purpose (such as “RELIEF FROM HEAT (PREVENTING HEATSTROKE)”) particularly requiring air conditioning among non-driving purposes involving getting into the vehicle.

As described above, the vehicle management system 1 includes the memory 30 that functions as a storage unit storing the schedule information 33 and the reservation accepting unit 11 determining whether a reservation for a rental vehicle is to be accepted or not based on the schedule information 33. If the use time zone X corresponding to a reservation is within a charging time zone ZD (see FIG. 7A, FIG. 7B, FIG. 8A, FIG. 8B, FIG. 9A, and FIG. 9B) set in the schedule information 33 and if its use purpose is a non-driving purpose, the reservation accepting unit 11 accepts the reservation and, if the use purpose is a driving purpose, does not accept the reservation. Thus, a rental vehicle while being charged can be rented out for a non-driving purpose so that the operating ratio of the rental vehicle requiring charging can be easily improved. For a non-driving purpose, none of users of a rental vehicle is required to carry his or her driver's license so that the range of users for the rental vehicle can be extended. Therefore, when a service that rents out rental vehicles to be shared by a plurality of users is performed, acquisition of sales and early recovery of initial investment can be easily attempted.

Furthermore, for a reservation for a non-driving purpose, the reservation accepting unit 11 accepts the reservation if a free time TF1, TF0 (see FIG. 7A, FIG. 7B, FIG. 8A, FIG. 8B, FIG. 9A, and FIG. 9B) to which the required charging time TC corresponding to the reservation can be allocated exists before a use time zone (corresponding to “DRIVING USE 1-2” in FIG. 7A, FIG. 7B, FIG. 8A, FIG. 8B, FIG. 9A, and FIG. 9B) set immediately after the use time zone X corresponding to the reservation. Thus, charging for use for a non-driving purpose can be secured, and an influence on use for a driving purpose reserved after a use for a non-driving purpose can be suppressed.

For a reservation for a non-driving purpose, when a free time TF1 to which the required charging time TC corresponding to the reservation can be allocated exists between the use time zone X corresponding to the reservation and the use time zone (corresponding to “DRIVING USE 1-1” in FIG. 7A and FIG. 7B) set immediately before the use time zone X, the information managing unit 16 sets, within the free time TF1, a charging time zone Z (“CHARGING 1G-1” in FIG. 7A and FIG. 7B) corresponding to the reservation, as shown in FIG. 7A and FIG. 7B. Thus, the charging time zone Z can be set such that the electricity to be consumed by the use for the non-driving purpose can be charged in advance and that an influence on the subsequent driving use can be suppressed.

In accordance with the use purpose corresponding to an accepted reservation, the vehicle control unit 17 selectively performs the pre-air conditioning control that starts an air-conditioning operation at a time before the use time zone X corresponding to the reservation. Thus, a proper temperature can be acquired in advance within the vehicle in accordance with the use purpose.

In this case, if the use purpose is a non-driving purpose involving getting into the vehicle, the vehicle control unit 17 performs the pre-air conditioning control, and, if the use purpose is a purpose not involving getting into the vehicle, does not perform the pre-air conditioning control. Thus, a comfortable environment can be provided to a user who uses the inside of the vehicle for a non-driving purpose while consumption of electricity can be suppressed if the inside of the vehicle is not used.

Because, if the use purpose corresponding to a reservation is a non-driving purpose, the vehicle selecting unit 15 selects a rental vehicle to be reserved in accordance with details of the non-driving purpose, a proper rental vehicle according to the non-driving purpose can be rented out. Therefore, an increase of the number of users for non-driving purposes can be easily attempted, and the opportunity for renting is not easily lost even when the number of uses for non-driving purposes increases, which is advantageous for improvement of the operating ration of the rental vehicles.

Having described that, according to the aforementioned embodiment, the present invention is applied to the vehicle management system 1 shown in FIG. 1 and so on and the vehicle management method, embodiments are not limited thereto. For example, the vehicle management system 1 may be configured by a distribution system in which works are divided and performed by a plurality of computers connected by the communication network 100 or may be configured by one computer. Examples of the computer in that case include a minicomputer, an office computer, a server, a workstation, a personal computer, and a mobile information terminal.

The configurations of the components shown in FIG. 1 may be implemented by hardware or may be implemented by cooperation of hardware and software. The data structures shown in, for example, FIG. 2 to FIG. 5 are not limited to the shown examples. How the processing units in the flowcharts shown in FIG. 6 and FIG. 10 are to be divided or the processing order are not limited to the shown examples.

The control program 31 may be stored in an external apparatus or device and may be acquired through, for example, the communication unit 40. The control program 31 may be recorded in a computer-readable recording medium. The recording medium may be a magnetic or an optical recording medium or a semiconductor memory device. More specifically, a portable or fixed recording medium may be used such as a flexible disk, various kinds of optical disk, a magneto-optical disk, a flash memory, or a card-type recording medium. The recording medium may be a non-volatile storage device such as a RAM, ROM, or HDD that is an internal storage device included in the vehicle management system 1.

### REFERENCE SIGNS LIST

1: vehicle management system, 10: CPU (computer), 11: reservation accepting unit, 12: amount-of-electricity identifying unit, 13: remaining amount estimating unit, 14: charging time identifying unit, 15: vehicle selecting unit, 16: information managing unit, 17: vehicle control unit, 30: memory, 31: control program, 32: vehicle information, 33: schedule information, 34: vehicle selection information, 40: communication unit, 50: communication terminal, 70, 80, 90: rental vehicle (electric vehicle), 71, 81, 91: ECU, 72, 82, 92: storage battery, 75, 85, 95: standby location, 100: communication network, Pu: user, DR: reservation subscription information, DA: reservation information, X: use time zone, Z, ZD: charging time zone, TF, TF0, TF1: free time

What is claimed is:

1. A vehicle management system that manages use and charging of an electric vehicle to be shared by a plurality of users, the system comprising:
a storage unit storing schedule information in which a use time zone and a charging time zone for the electric vehicle are set; and
a reservation accepting unit determining whether a reservation for the electric vehicle is to be accepted or not based on the schedule information,
wherein the reservation includes information by which a use time zone for the electric vehicle and a use purpose of the electric vehicle can be identified, and
the reservation accepting unit accepts the reservation if the use time zone corresponding to the reservation is within the charging time zone set in the schedule information and if the use purpose is a non-driving purpose.

2. The vehicle management system according to claim 1, further comprising:
an amount-of-electricity identifying unit identifying a required amount of electricity based on details of the reservation; and
a charging time identifying unit identifying a required charging time based on the required amount of electricity,
wherein the reservation accepting unit accepts the reservation if the reservation is for the non-driving purpose and if a free time to which the required charging time corresponding to the reservation can be allocated exists before a use time zone set immediately after the use time zone corresponding to the reservation.

3. The vehicle management system according to claim 2, further comprising:
an information managing unit setting, in the schedule information, the use time zone corresponding to the reservation and a charging time zone corresponding to the reservation if the reservation is accepted,
wherein if the reservation is for the non-driving purpose and if a free time to which the required charging time corresponding to the reservation can be allocated exists between the use time zone corresponding to the reservation and a use time zone set immediately before the use time zone, the information managing unit sets the charging time zone corresponding to the reservation within the free time.

4. The vehicle management system according to claim 1, further comprising:
a vehicle control unit which can externally control air conditioning in the electric vehicle,
wherein the vehicle control unit selectively performs pre-air conditioning control which starts an air conditioning operation at a time before the use time zone corresponding to the reservation in accordance with the use purpose corresponding to the accepted reservation.

5. The vehicle management system according to claim 4, wherein, if the use purpose is a non-driving purpose involving getting into the vehicle, the vehicle control unit performs pre-air conditioning control which operates air conditioning in the electric vehicle before the electric vehicle is started to use and, if the use purpose is a non-driving purpose not involving getting into the vehicle, does not perform the pre-air conditioning control.

6. The vehicle management system according to claim 1, wherein
the reservation accepting unit has a vehicle selecting unit selecting an electric vehicle to be reserved based on details of the reservation, and
if the use purpose corresponding to the reservation is a non-driving purpose, the vehicle selecting unit selects an electric vehicle to be reserved in accordance with details of the non-driving purpose.

7. A vehicle management method to be executed by a computer for managing use and charging of an electric vehicle to be shared by a plurality of users, the method comprising:
a reservation accepting step of determining whether a reservation for the electric vehicle is to be accepted or not based on schedule information in which a use time zone and a charging time zone for the electric vehicle are set,
wherein the reservation includes information by which a use time zone for the electric vehicle and a use purpose of the electric vehicle can be identified, and the reservation accepting step accepts the reservation if the use time zone corresponding to the reservation is within the charging time zone set in the schedule information and if the use purpose is a non-driving purpose.
